(19) United States
(12) Patent Application Publication
(10) Pub. No.: US 2015/0317987 A1
(43) Pub. Date: Nov. 5, 2015

(54) METHOD AND A DEVICE FOR REACTING TO WATERMARKS IN DIGITAL CONTENT

(71) Applicant: THOMSON LICENSING, Issy de Moulineaux (FR)

(72) Inventors: Eric DIEHL, Issy les Moulineaux (FR); Louis Kirk Barker, Rockwell, TX (US)

(21) Appl. No.: 14/676,032

(22) Filed: Apr. 1, 2015

(30) Foreign Application Priority Data
Apr. 7, 2014 (EP) 14305499.7

(51) Int. Cl. G10L 19/018; H04R 1/08

(52) U.S. Cl. CPC G10L 19/018; H04R 1/08

(57) ABSTRACT

A device for reacting to watermarks embedded in digital content, comprising a capture module configured to capture digital content; a watermark extraction module configured to extract watermarks embedded in captured digital content; an interpreter module configured to interpret extracted watermarks and to send commands corresponding to interpretations of extracted watermarks; a storage module configured to store digital content; a rendering module configured to render digital content stored in the storage module in response to a command from the interpreter module to render digital content; a recorder module configured to record digital content captured by the capture module upon reception of a command from the interpreter; and an encoder module configured to encode digital content recorded by the recorded module and to store encoded digital content in the storage module.

### TECHNICAL FIELD

The present disclosure relates generally to devices interacting with watermarks in digital content.

### BACKGROUND

This section is intended to introduce the reader to various aspects of art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

For a few years, it has become increasingly common to see digital content that has been digitally watermarked with a payload that can cause an object to react in a certain manner when the digital content is rendered. An example of this is a toy that appears to react to the action in a cartoon when it in fact reacts to one or more (usually audio) watermarks embedded in the cartoon. As digital watermarking is a mature technology, it will not be described in detail as it is assumed that the skilled person is well aware of how watermarks are inserted, detected, extracted and so on.

In order to accomplish this, as illustrated in FIG. 1 using an exemplary audio watermark, such a prior art object 100 generally comprises a microphone 110 for capturing rendered audio, a module 120 for extracting a watermark from the captured audio and for extracting a payload from the extracted watermark. The object further comprises a module 130 for interpreting the payload and for causing the object to perform an action corresponding to the interpretation.

A drawback with such objects is that it is difficult or even impossible to update them with further watermarks and corresponding actions once they are in the hands of an end user. In cases when this is possible, it is necessary for the user to connect the object in some way to a server in order to download the updates. This is not very user-friendly and it also increases the cost of the object since it is necessary to provide it with the necessary hardware and software.

It will thus be appreciated that it is desired to have an object that can be updated in a simple manner.

### SUMMARY OF DISCLOSURE

In a first aspect, the disclosure is directed to a device for reacting to watermarks embedded in digital content. The device comprises a capture module configured to capture digital content; a watermark extraction module configured to extract watermarks embedded in captured digital content; an interpreter module configured to interpret extracted watermarks and to send commands corresponding to interpretations of extracted watermarks; a storage module configured to store digital content; a rendering module configured to render digital content stored in the storage module in response to a command from the interpreter module to render digital content; a recorder module configured to record digital content captured by the capture module upon reception of a command from the interpreter; an encoder module configured to encode digital content recorded by the recorded module and to store encoded digital content in the storage module.

In a first embodiment, the digital content is audio content and the watermark is an audio watermark.

In a second embodiment, stored digital content are associated with an index value and wherein commands to render digital content and commands to record digital content sent from the interpreter module comprise at least one index value.

In a third embodiment, stored digital content are stored at specific memory addresses and wherein commands to render digital content and commands to record digital content sent from the interpreter module comprise at least one memory address.

In a second aspect, the disclosure is directed to a method for reacting by a device to watermarks embedded in received digital content. A capture module captures the received digital content; a watermark extraction module extracts a watermark embedded in the captured received digital content; and an interpreter module interprets the extracted watermark. In case the extracted watermark is interpreted as an instruction to render a stored digital content, a rendering module renders the stored digital content. In case the extracted watermark is interpreted as an instruction to record the received digital content, a recorder module records part of the digital content captured by the capture module to obtain recorded content; an encoder module encodes the recorded content to obtain encoded content; and a storage module stores the encoded content as stored content.

In a first embodiment, the digital content is audio content and the watermark is an audio watermark.

In a second embodiment, stored digital content are associated with an index value and wherein the instruction to render a stored digital content and the instruction to record digital content each comprises at least one index value.

In a third embodiment, stored digital content are stored at specific memory addresses and wherein the instruction to render a stored digital content and the instruction to record digital content each comprises at least one memory address.

In a third aspect, the disclosure is directed to a non-transitory computer-readable storage medium comprising instructions that, when executed by a processor, perform the method of the second embodiment.

### BRIEF DESCRIPTION OF DRAWINGS

Preferred features of the present disclosure will now be described, by way of non-limiting examples, with reference to the accompanying drawings, in which:

FIG. 1 illustrates an exemplary prior art object;

FIG. 2 illustrates an exemplary device according to the present disclosure; and

FIG. 3 illustrates a method at a device according to the present disclosure.

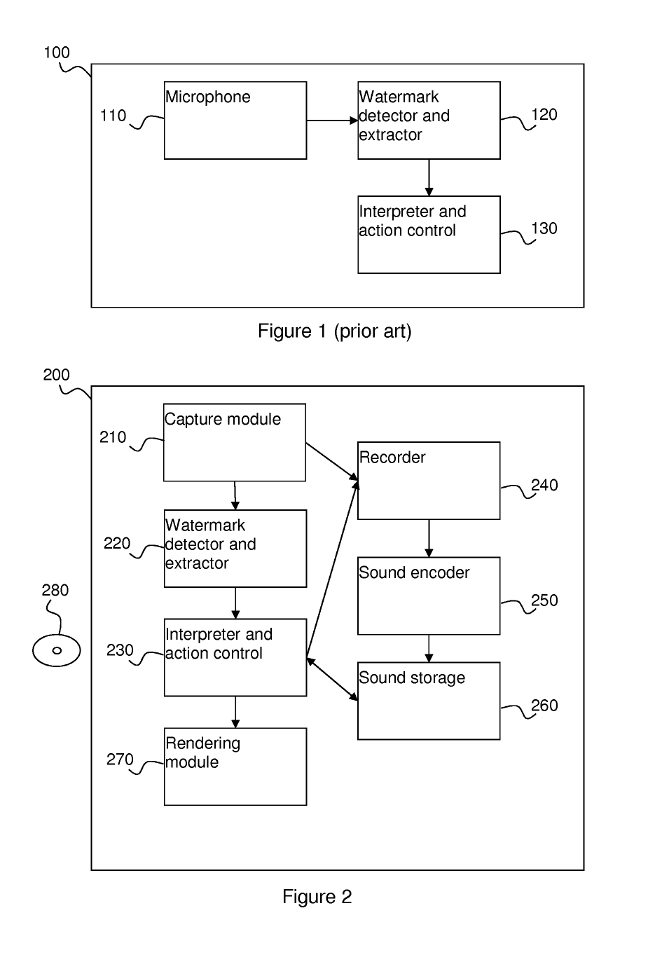

### DESCRIPTION OF EMBODIMENTS

FIG. 2 illustrates an exemplary device 200 according to the present disclosure. The device 200 comprises a capture module 210 (such as a microphone) configured to capture audio (i.e. sound), an extraction module 220 configured to extract audio watermarks from the captured audio and to extract watermark payloads from the extracted watermarks, a control module 230 configured to interpret the extracted payloads and to control actions in response to the interpreted payloads, and a module 270 (such as a speaker) configured to render audio received from the control module 230. The device 200 further comprises a recording module 240 configured to record the audio captured by the capture module 210, a sound coder module 250 configured to encode (i.e. digitize) the recorded audio into a suitable digital format such as mp3, and a sound storage module 260 (such as a suitable memory) configured to store encoded audio as audio items and to output stored audio items for rendering.

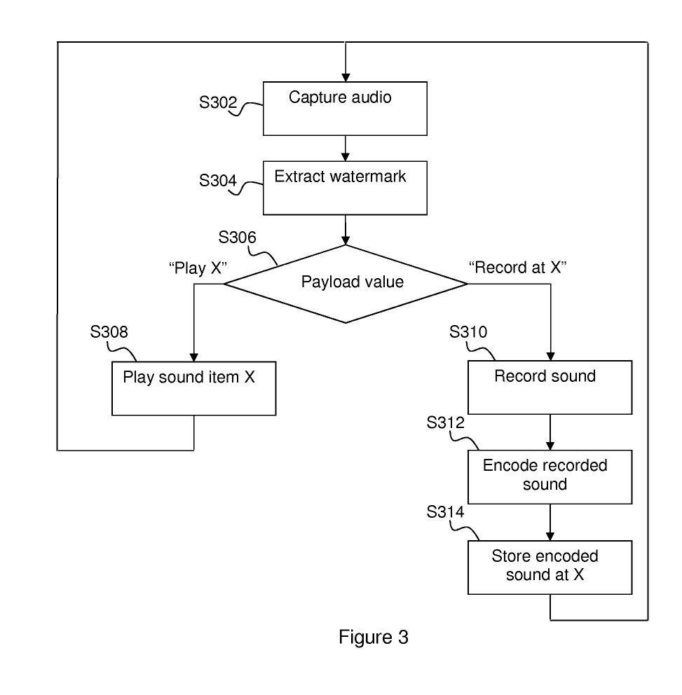

In FIG. 2, various modules are described as functional entities that are implemented in suitable hardware, software or hardware and software modules. For example, the extraction module 220, the control module 230, the recording module 240, the sound coder module 250 and even the sound storage module 260 can be implemented in one or more hardware processors (with suitable software). FIG. 2 also illustrates a non-transitory computer-readable storage medium 280 that, when executed by a processor, these instructions perform the method of the present disclosure, an exemplary illustration of which is found in FIG. 3.

FIG. 3 illustrates a method at a device according to the present disclosure. The capture module 210 captures audio S302 rendered by some rendering device (not shown), the extraction module 220 extracts an (generally, a single watermark is transmitted at a single time) audio watermark S304 from the captured audio and extracts a watermark payload from the extracted watermark, and the control module 230 interprets the extracted payload S306.

The possible payloads comprise values that are interpreted as “Play audio item X”, which means that the control module 230 is to play the audio item S308 indicated as X in the sound storage module 260. X can for example be a memory address in the sound storage module 260 or an index that corresponds to a stored audio item.

Other possible payloads include values that are interpreted as “Record audio and store item”. This payload causes the recording module 240 to record S310 the sound captured by the capture module 210. How much sound the recording module 240 is to record can be provided in the payload, e.g. “546 ms”, but it is also possible to use a default value or to provide an index that corresponds to prestored time values. This also holds true for when the sound is to be recorded, e.g. “in 213 ms” “directly after trigger watermark ABCD” or at a default delay after arrival of the watermark. The recorded sound is then encoded S312 by the sound coder module 250 into a format suitable for storage. The encoding performed by the sound coder module 250 can also comprise audio processing such as filtering and change of frequency. The sound coder module 250 then stores S314 the encoded recorded sound in the sound storage module 260 in such a way that the recording is associated with ‘X’ so that the recording may be retrieved later. The value of X can in one embodiment be extracted from the captured watermark with the instructions to record the sound, while another embodiment simply increments X (modulo the maximum value).

It is preferred that the device waits until it has played or recorded a sound before it is ready to capture another watermark, but it should be noted that it is possible to capture a watermark (and then perform a corresponding action) while another action—i.e. playing or recording—is ongoing.

While the present disclosure has been described for audio content, it will be appreciated that other kinds of digital content, such as video content, could also be used.

As can be seen, the present disclosure can thus provide a method in which the recorded sounds can be updated without the need of a back channel or user interaction.

Each feature disclosed in the description and (where appropriate) the claims and drawings may be provided independently or in any appropriate combination. Features described as being implemented in hardware may also be implemented in software, and vice versa. Reference numerals appearing in the claims are by way of illustration only and shall have no limiting effect on the scope of the claims.

1. A device for reacting to watermarks embedded in digital content, the device comprising:
a capture module configured to capture digital content;
a watermark extraction module configured to extract watermarks embedded in captured digital content;
an interpreter module configured to interpret extracted watermarks and to send commands corresponding to interpretations of extracted watermarks;
a storage module configured to store digital content; and
a rendering module configured to render digital content stored in the storage module in response to a command from the interpreter module to render digital content;
a recorder module configured to record digital content captured by the capture module upon reception of a command from the interpreter;
an encoder module configured to encode digital content recorded by the recorded module and to store encoded digital content in the storage module.

2. The device of claim 1, wherein the digital content is audio content and the watermark is an audio watermark.

3. The device of claim 1, wherein stored digital content are associated with an index value and wherein commands to render digital content and commands to record digital content sent from the interpreter module comprise at least one index value.

4. The device of claim 1, wherein stored digital content are stored at specific memory addresses and wherein commands to render digital content and commands to record digital content sent from the interpreter module comprise at least one memory address.

5. A method for reacting by a device to watermarks embedded in received digital content, the method comprising:
capturing by a capture module the received digital content;
extracting by a watermark extraction module a watermark embedded in the captured received digital content;
interpreting by an interpreter module the extracted watermark; and
in case the extracted watermark is interpreted as an instruction to render a stored digital content, rendering by a rendering module the stored digital content; and
in case the extracted watermark is interpreted as an instruction to record the received digital content:
recording by a recorder module part of the digital content captured by the capture module to obtain recorded content;
encoding by an encoder module the recorded content to obtain encoded content; and
storing in a storage module the encoded content as stored content.

6. The method of claim 5, wherein the digital content is audio content and the watermark is an audio watermark.

7. The method of claim 5, wherein stored digital content are associated with an index value and wherein the instruction to render a stored digital content and the instruction to record digital content each comprises at least one index value.

8. The method of claim 5, wherein stored digital content are stored at specific memory addresses and wherein the instruction to render a stored digital content and the instruction to record digital content each comprises at least one memory address.

9. A non-transitory computer-readable storage medium comprising instructions that, when executed by a processor, perform the method of claim 5.
